(19) United States
(12) Patent Application Publication
(10) Pub. No.: US 2024/0336756 A1
(43) Pub. Date: Oct. 10, 2024

(54) POLYMER FOAM, METHODS AND USE RELATED THERETO

(71) Applicant: WOODLY OY, Helsinki (FI)

(72) Inventors: Upi ANTTILA, Helsinki (FI); Martta ASIKAINEN, Helsinki (FI); Tommi VUORINEN, Helsinki (FI); Tomi NYMAN, Helsinki (FI); Teijo ROKKONEN, Tampere (FI); Lisa WIKSTRÖM, Tampere (FI)

(21) Appl. No.: 18/718,943

(22) PCT Filed: Nov. 28, 2022
(86) PCT No.: PCT/FI2022/050794

§ 371 Date: Jun. 12, 2024

(30) Foreign Application Priority Data
Dec. 17, 2021 (FI) 20216297

(51) Int. Cl. C08J 9/00; C08J 9/12; C08K 3/26; C08K 3/34

(52) U.S. Cl. CPC C08J 9/0061; C08J 9/0066; C08J 9/122; C08K 3/26; C08K 3/34; C08J 2203/06; C08J 2301/12; C08J 2367/03; C08K 2003/265; C08K 2201/005

(57) ABSTRACT

The disclosure concerns a polymer foam comprising cellulose acetate propionate and a second polymer selected from a group several polymers, and at least one nucleating agent and the foam is manufactured by using at least one blowing agent. Furthermore, an article, a method and use related thereto are described.

### PRIOR RELATED APPLICATIONS

The present application is a national entry of pct application no. PCT/FI2022/050794, filed on Nov. 28, 2022, which claims priority under the Paris Convention to Finnish Application No. FI 20216297, filed on Dec. 17, 2021. the entire contents of such prior applications are incorporated by reference herein.

### TECHNICAL FIELD

The present disclosure relates to polymer foams and to their manufacturing. Especially, a polymer foam comprising cellulose acetate propionate (CAP), a second polymer, a nucleating agent and a blowing agent is described.

### BACKGROUND

Polymer foams, also known as cellular plastics, are materials made by combination of solid and gaseous phases. Polymer foams are attractive due to their low density, good heat insulation, good sound insulation, and high specific strength.

Polymer foams are typically manufactured by various foaming methods. Such methods include extrusion foaming, particle bead foaming, autoclave foaming and foam injection molding. Polymers of various types are expanded into porous or cellular materials by using blowing agents.

There are many applications for polymer foams, the most important being in packaging, acoustics, thermal insulation, automotive, sports equipment, light weight components and construction.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject-matter.

The present disclosure concerns a polymer foam, wherein said polymer foam material comprises
cellulose acetate propionate (CAP),
a second polymer selected from an aliphatic or an aliphatic-aromatic polyester, an aliphatic or an aliphatic-aromatic co-polyester, or a polylactide,
at least one nucleating agent, and
in that the polymer foam has been manufactured by using at least one blowing agent.

Disclosed is also a method for manufacturing a polymer foam, wherein the method comprises the steps of;
providing cellulose acetate propionate (CAP) and a second polymer selected from an aliphatic or an aliphatic-aromatic polyester or an aliphatic or an aliphatic-aromatic co-polyester, or a polylactide,
mixing said cellulose acetate propionate (CAP) and said second polymer with at least one blowing agent and at least one nucleating agent to obtain a polymer mixture,
forming said polymer mixture into a polymer foam by using a foam producing method and obtaining a polymer foam.

The present disclosure also describes an article and use related to the disclosed polymer foam.

### BRIEF DESCRIPTION OF THE DRAWINGS

The accompanying drawings, which are included to provide a further understanding of the embodiments and constitute a part of this specification, illustrate embodiments. In the drawings:

FIGS. 1 and 2 illustrate Reference Example 4, Scanning electron microscopy of a polymer foam sample 1

FIGS. 3 and 4 illustrate Example 5, Scanning electron microscopy of a polymer foam sample 2

FIGS. 5 and 6 illustrate Example 5, Scanning electron microscopy of a polymer foam sample 3

FIGS. 7 and 8 illustrate Example 5, Scanning electron microscopy of a polymer foam sample 4

FIGS. 9 and 10 illustrate Example 5, Scanning electron microscopy of a polymer foam sample 5

FIGS. 11 and 12 illustrate Example 5, Scanning electron microscopy of a polymer foam sample 6

FIGS. 13 and 14 illustrate Example 5, Scanning electron microscopy of a polymer foam sample 7

FIGS. 15 and 16 illustrate Example 5, Scanning electron microscopy of a polymer foam sample 8

FIGS. 17 and 18 illustrate Example 5, Scanning electron microscopy of a polymer foam sample 9

FIGS. 19 and 20 illustrate Example 5, Scanning electron microscopy of a polymer foam sample 10

FIGS. 21 and 22 illustrate Example 5, Scanning electron microscopy of a polymer foam sample 11

FIGS. 23 and 24 illustrate Example 5, Scanning electron microscopy of a polymer foam sample 12

FIGS. 25 and 26 illustrate Example 5, Scanning electron microscopy of a polymer foam sample 13

FIGS. 27 and 28 illustrate Example 5, Scanning electron microscopy of a polymer foam sample 14

### DETAILED DESCRIPTION

Polymer foams, also known as cellular plastics, are important products for plastics industry and consumers. Currently, the most used plastics for polymer foams are polyurethane, polystyrene, polyethylene, and polyvinyl chloride. These products are not considered as environmentally friendly as they typically have low renewable content and high carbon footprint. Also, the recycling of many of these commonly used plastics in foam applications is considered difficult.

The present disclosure describes new polymer foams. This disclosure is based on the finding that high-quality polymer foams can be obtained using a polymer blend comprising at least two polymers. The present disclosure can provide a polymer foam based on renewable materials, which polymer foam can be used to manufacture various articles for industry and consumer use. The polymer foams disclosed herein, and articles manufactured therefrom could replace foams based on purely fossil raw materials. Thus, the polymer foam of this disclosure, and the articles manufactured therefrom provide a more sustainable material option for plastics industry and consumers.

The present disclosure concerns a polymer foam, wherein said polymer foam material comprises
cellulose acetate propionate (CAP),
a second polymer selected from an aliphatic or an aliphatic-aromatic polyester, an aliphatic or an aliphatic-aromatic co-polyester, or a polylactide,
at least one nucleating agent, and
in that the polymer foam has been manufactured by using at least one blowing agent.

Disclosed is also a method for manufacturing a polymer foam, wherein the method comprises the steps of;
providing cellulose acetate propionate (CAP) and a second polymer selected from an aliphatic or an aliphatic-aromatic polyester or an aliphatic or an aliphatic-aromatic co-polyester, or a polylactide,
mixing said cellulose acetate propionate (CAP) and said second polymer with at least one blowing agent and at least one nucleating agent to obtain a polymer mixture,
forming said polymer mixture into a polymer foam by using a foam producing method and obtaining a polymer foam.

There are several methods for producing polymer foams. Typically, the process steps include introduction of a blowing agent in the polymer, initial cell formation with nucleation, cell growth of the nucleated cells, and stabilization of the expanded cells.

Polymer foams are typically produced so, that the foaming temperature is below or near the transition temperature of the polymer used. This is due to the fact, that blowing agents act as plasticisers. Lowering of the temperature is also necessary to reduce polymer viscosity to effectively stabilize the cellular structure. Also, as the blowing agent, such as CO₂, must diffuse out of the polymer foam structure and be replaced by air as the polymer foam is still cooling down, an unstable polymer foam would easily collapse in the under pressure formed by the diffusion.

This disclosure describes polymer foams made with a polymer blend, which comprises at least two polymers, and in addition at least one nucleating agent is used and at least one blowing agent is used in the manufacturing of the polymer foam. The two polymers used may have clearly different melting points and glass transition temperatures.

Generally, if using two polymers in a polymer foam, and if the melting points and glass transition temperatures are clearly different, it can be difficult to obtain a high-quality polymer foam. If the melting point of the second polymer is clearly below the foaming temperature, it would be expected that the polymer with the low melting point would collapse during the foam formation, cooling, and diffusion of the blowing agent. This phenomenon is expected to take place when larger quantities of the second polymer are used.

The inventors discovered, that when using cellulose acetate propionate (CAP), and for example polybutylene succinate (PBS) as the polymers in the polymer foam, high quality foams were obtained even though the melting points of the two polymers are rather different. The two polymers illustrated in the examples have clearly different melting points and glass transition temperatures. As the melting point of the CAP polymer is between 188-210° C., and that of the PBS polymer is 115° C., and the foaming temperatures of the polymer foam samples are between 155° C. and 195° C., it would be expected that the polymer with the low melting point would collapse during the foam formation, cooling, and diffusion of the CO₂.

Therefore, it is surprising, that the polymer blends illustrated in the examples, having up to 30 weight-% of the PBS polymer, can form stable polymer foams with a stable cellular structure and low density. This effect is obtained as a combination of blowing agent and a nucleating agent.

It is expected that polymers with similar chemical structure, melting point, or glass transition temperature, may give similar results as the above described specific embodiment illustrated by the examples. The second polymer may be aliphatic polyesters or co-polyesters. The second polymer may also be an aliphatic-aromatic polyester or co-polyester. The second polymer may also be a polylactide.

The polymer foams described herein comprise at least two polymers. The first polymer is cellulose acetate propionate (CAP), and the second polymer is selected from an aliphatic or an aliphatic-aromatic polyester, an aliphatic or an aliphatic-aromatic co-polyester, or a polylactide.

According to an embodiment, the polymer foam comprises a combination of cellulose acetate propionate (CAP) and said second polymer in an amount of at least 80 weight-%, or at least 85 weight-%, or at least 90 weight-%, or at least 95 weight-%, based on the total weight of the polymer foam.

The polymer foam can also comprise the combination of cellulose acetate propionate (CAP) and said second polymer in an amount of at least 70 weight-%, or at least 75 weight-%, based on the total weight of the polymer foam.

In the polymer blend, CAP and said second polymer can be present in different quantities.

According to one embodiment, the polymer foam comprises the CAP in an amount of 30 to 95 weight-%, or 40 to 95 weight-%, or 50 to 90 weight-%, or 55 to 90 weight-%, or 60 to 90 weight-%, or 70 to 90 weight-%, and said second polymer in an amount of 5 to 70 weight-%, or 5 to 60 weight-%, or 10 to 50 weight-%, 10 to 45 weight-%, or 10 to 40 weight-%, or 10 to 30 weight-%, based on the total weight of the polymer foam.

The polymer foam can also comprise CAP in an amount of 50 to 95 weight-%, or 55 to 95 weight-%, or 60 to 95 weight-%, 65 to 95 weight-% or 70 to 95 weight-%, or 75 to 95 weight-%, or 80 to 95 weight-%, and said second polymer in an amount of 5 to 50 weight-%, 5 to 45 weight-%, or 5 to 40 weight-%, 5 to 35 weight-%, 5 to 30 weight-%, or 5 to 25 weight-%, or 5 to 20 weight-%.

According to an embodiment, the polymer foam comprises a second polymer selected from an aliphatic or an aliphatic-aromatic polyester, an aliphatic or an aliphatic-aromatic co-polyester, and a polylactide.

The second polymer can be a polyester or a polylactide with a relatively low melting point and a relatively low glass transition temperature. It is illustrated in the examples that a polymer of this type gives high quality polymer foams despite the large difference of the melting point and glass transition temperature of the second polymer and cellulose acetate propionate.

According to an embodiment, the polymer foam comprises said second polymer being selected from the group consisting of polypropylene succinate (PPS), polybutylene succinate (PBS), polybutylene succinate adipate (PBSA), polybutylene adipate terephthalate (PBAT), polybutylene adipate (PBA), polycaprolactone (PCL), polyhydroxyalkanoate (PHA), and polybutylene sebacate (PBSE), or combinations thereof.

According to an embodiment, the polymer foam comprises said second polymer having a melting point of 180° C. or less, or 170° C. or less, or 160° C. or less, or 150° C. or less. According to one specific embodiment, the polymer foam comprises said second polymer having a melting point 140° C. or less, or 130° C. or less, or 120° C. or less. The melting point of the second polymer can be for example 110° C., or 115° C., or 120° C. According to one very specific embodiment, the melting point is between 180° C. and 60° C., or between 170° C. and 80° C.

According to an embodiment, the polymer foam comprises said second polymer having a glass transition temperature (Tg) of 20° C. or less, or 10° C. or less, or 0° C. or less, or −10° C. or less, or −20° C. or less, or −25° C. or less. The glass transition temperature of the second polymer can be for example −28° C., or −32° C., or −35° C. According to one very specific embodiment, the glass transition temperature of the second polymer is between 20° C. and −40° C., or between 10° C. and −20° C.

According to one specific embodiment, the polymer foam comprises said second polymer being polybutylene succinate (PBS).

Further, the second polymer can be a polyester or a polylactide with a relatively high melting point and a relatively high glass transition temperature. It would be expected that these polyesters and polylactides would also result in high quality foams. As the melting points and the glass transition temperatures of these polyesters and polylactides are close to the cellulose acetate propionate polymer, stable polymer foams are expected.

According to an embodiment, the polymer foam comprises said second polymer being selected from the group consisting of polylactic acid (PLA), polyethylene furanoate (PEF), polyethylene terephthalate (PET), polybutylene terephthalate (PBT), polytrimethylene terephthalate (PTT), and polyglycolic acid (PGA), or combinations thereof.

According to an embodiment, the polymer foam comprises said second polymer having a melting point of 300° C. or less, or 270° C. or less, or 265° C. or less.

According to an embodiment, the polymer foam comprises said second polymer having a glass transition temperature (Tg) 100° C. or less, or 90° C. or less, or 85° C. or less.

According to an embodiment, the polymer foam comprises said second polymer, and the said second polymer is produced fully or partially by a bioprocess such as fermentation process. According to an embodiment, the second polymer has residual nitrogen content of 0.01 to 1000 ppm.

Suitably, when CAP is used, the number average molar mass of the CAP polymer is above 20,000 Da. According to one embodiment, the number average molar mass is between 30,000 to 110,000 Da, typically between 50,000 to 100,000 Da, or 65,000 to 95,000 Da. The number average molar mass may be between 85,000 and 95,000 Da, or between 85,000 and 91,000 Da, for example 90,000 Da, 91,000 Da or 92,000 Da. A number average molar mass within the above defined ranges may provide a resilient material with mechanical properties for producing polymer foams.

All number average molar mass measurements performed in connection with this disclosure were measured with size exclusion chromatography (SEC) using chloroform eluent for the number average molar mass measurements. The SEC measurements were performed in chloroform eluent (0.6 ml/min, T=30° C.) using Styragel HR 4 and 3 columns with a pre-column. The elution curves were detected using Waters 2414 Refractive index detector. The molar mass distributions (MMD) were calculated against 10×PS (580-3040000 g/mol) standards, using Waters Empower 3 software.

Different grades of cellulose esters, such as cellulose acetate propionate, are commercially available from several suppliers. In the disclosed polymer foam, the polymer raw materials affect the properties of the formed mixture. In other words, the combined properties of the polymers need to be evaluated when forming the polymer blend for the polymer foam. For example, if one of the polymers has a high number average molar mass, such as 90,000 Da or 70,000 Da, it could be suitable to combine this polymer with another polymer having a lower number average molar mass. Alternatively, or additionally, for example a softener may be used together with polymers with a high molar mass. The suitable number average molar mass depends on the end use of the foam, i.e. the most suitable cellulose ester grade may be different depending on the intended end use. Cellulose esters may have different grades of substitution. The CAP suitable for the polymer foam suitably has an acetyl content of 0 to 40 weight-%, or 0.5 to 30 weight-%, or 0.5 to 25 weight-%, or 0.5 to 15 weight-%, or 0.5 to 5.0 weight-%, or 0.8 to 2.0 weight-%. Typically, 1.0 to 1.5 weight-%, for example 1.3 weight-%. The CAP suitable for the described polymer foams suitably has a propionyl content of 5 to 51 weight-%, or 15 to 51 weight-%, or 30 to 51 weight-%. It may also be for example 18 weight-%, or 20 weight-%, or 25 weight-%. Typically, it may be 40 to 50 weight-%. A very specific example is 48 weight-%. The CAP suitable for the described polymer foams suitably has hydroxyl content of 0.5 to 5.0 weight-%, or 0.5 to 3.0 weight-%, or 1.0 to 2.5 weight-%. Typically, 1.5 to 2.0 weight-%, for example 1.7 weight-%. In addition, the glass transition temperature is suitably 140° C. to 155° C. Typically, 142° C. to 152° C., for example 147° C.

According to one specific embodiment, CAP has an acetyl content of 0.8 to 2.0 weight-%, or 1.0 to 1.5 weight-%, and/or a propionyl content of 30 to 51 weight-%, or 40 to 50 weight-%, or 45 to 50 weight-%, and/or a hydroxyl content of 1.0 to 2.5 weight-%, or 1.5 to 2.0 weight-%.

According to one specific embodiment, CAP has a glass transition temperature of 100° C. to 170° C., or 120° C. to 160° C., or 140° C. to 150° C.

According to one specific embodiment, CAP has a melting point of 130° C. to 230° C., or 140° C. to 220° C., or 180° C. to 220° C., or 185° C. to 210° C.

According to one specific embodiment, the second polymer is PBS.

According to one embodiment, if PBS is used, the PBS suitable for the polymer foams has a number average molar mass in the range of 30,000 to 100,000 Da. Typically, 50,000 to 80,000 Da; or 60,000 to 70,000 Da. The number average molar mass of the PBS may be for example 65,000 to 70,000 Da, such as for example 68,000 Da, 69,000 Da or 70,000 Da.

According to one specific embodiment, PBS has a glass transition temperature of −50° C. to 0° C., or −40° C. to −10° C., or −35° C. to −25° C.

According to one specific embodiment, PBS has a melting point of 90° C. to 160° C., or 100° C. to 140° C., or 110° C. to 130° C., or 115° C. to 120° C.

According to one very specific embodiment, the polymer foam comprises cellulose acetate propionate in an amount of 60 to 95 weight-%, typically 65 to 95 weight-%, or 70 to 95 weight-%, or 70 to 90 weight-%, and PBS in an amount of 5 to 40 weight-%, typically 5 to 35 weight-%, or 5 to 30 weight-%, or 8 to 30 weight-% based on the total weight of the polymer foam.

Blowing agents are used to achieve the porous structure of the foam. Blowing agents are typically divided in physical blowing agents and chemical blowing agents.

Physical blowing agents can be divided into inorganic and organic blowing agents. Physical inorganic blowing agents may be for example nitrogen, carbon dioxide, water, argon, or air. Physical organic blowing agents may be low boiling point organic hydrocarbons, such as isobutane, n-butane, or n-pentane, cyclopentane, isopentane, or branched five carbon and six carbon alkanes such as isopentane, isohexane, or 2,3-dimethyl butane, or fluorocarbons or chlorofluorocarbons, such as dichloroethane, or Freon.

Chemical blowing agents are typically divided into inorganic and organic blowing or foaming agents. Chemical blowing agents act via two different methods, thermal decomposition, and chemical reaction. Inorganic chemical blowing agents include bicarbonates, such as sodium bicarbonate, carbonates, nitrites, zinc powder, chemical compounds giving acid reactions, and hydrogen peroxide. Organic chemical blowing agents include citric acid, azodicarbonamide, azodicarbondiamide, isocyanate compounds, nitroso foaming agents and acylhydrazine.

According to one specific embodiment, the polymer foam is manufactured by using a blowing agent such as nitrogen and/or carbon dioxide. These have been shown to work well with the polymers of this disclosure in the described solution.

Further suitable blowing agents can be found among the known blowing agents. According to one embodiment, at least one blowing agent is selected from the group consisting of nitrogen, carbon dioxide, water, argon, air, isobutane, n-butane, n-pentane, branched five carbon and six carbon alkanes such as isopentane, isohexane, or 2,3-dimethyl butane, fluorocarbons or chlorofluorocarbons such as dichloroethane, or Freon, bicarbonates such as sodium bicarbonate, carbonates, nitrites, zinc powder, chemical compounds giving acid reactions, hydrogen peroxide, citric acid, azodicarbonamide, azodicarbondiamide, isocyanate compounds, nitroso foaming agents, and acylhydrazine, or any combinations thereof.

According to one specific embodiment, the polymer foam is manufactured by using a blowing agent in an amount of 0.1 to 10 weight-%, or 0.3 to 10 weight-%, or 0.5 to 10 weight-%, or 0.5 to 7 weight-%, or 0.5 to 5 weight-%, or 1 to 5 weight-%, or 1 to 4 weight-%, or 1.5 to 3 weight-% based on the combined total weight of the said first and second polymers used. The blowing agent can also be used in an amount of 0.1 to 5 weight-%, or 0.1 to 4 weight-%, or 0.1 to 3.5 weight-%, or 0.3 to 3.5 weight-%. These have shown to work well with the polymers for the polymer foams of this disclosure in the described solution.

Nucleating agents can be used in the production of polymer foams. Nucleating agents improve the cell nucleation in the polymer foam, decreasing the cell size, bringing uniform cell morphology, and aiding in obtaining polymer foams with lower density and better tensile properties. Nucleating agents can be active nucleating agents, or act to impact the process properties, rheological properties of mechanical properties. Nucleating agents can be active or passive nucleation agents. Nucleating agents can be inorganic compounds such as talc, calcium carbonate, silica or silicate compounds, graphite, or calcium hydroxide. Organic nucleating agents can be natural waxes, polyethylene waxes, polyamide waxes, and other synthetic waxes, or stearates such as calcium stearate, zinc stearate, or aluminum stearate. Also, azodicarbonamide is used as nucleating agent. Also, combinations of several nucleation agents can be used. Nucleating agents can be added in the polymers as powders, liquids or in masterbatches.

According to one specific embodiment, the polymer foam comprises a nucleating agent such as talc and/or calcium carbonate. These have been shown to work well with the polymers for the polymer foams of this disclosure in the described solution.

Further suitable nucleating agents can be found among the known nucleating agents. According to one embodiment, at least one nucleating agent is selected from the group consisting of talc, calcium carbonate, silica or silicate compounds, graphite, calcium hydroxide, natural waxes, polyethylene waxes, polyamide waxes, or other synthetic waxes, stearates such as calcium stearate, zinc stearate, aluminum stearate, and azodicarbonamide, or any combinations thereof.

Nucleating agents used as solid particles can have different particle sizes. According to an embodiment, the nucleating agent has a median particle size of 0.5 to 10 μm, or 0.5 to 7 μm, or 1 to 5 μm, or 1 to 4 μm, or 1.5 to 3.5 μm or 1.5 to 3 μm. These have been shown to work well with the polymers for the polymer foams of this disclosure in the described solution.

The nucleating agents can be used in different quantities. According to an embodiment, the polymer foam comprises a nucleating agent in an amount of 0.05 to 10 weight-%, or 0.05 to 7 weight-%, or 0.1 to 5 weight-%, or 0.1 to 3 weight-%, or 0.1 to 1 weight-%, or 0.15 to 0.6 weight-%, based on the combined total weight of the said first and second polymers used. These have been shown to work well with the polymers for the polymer foams of this disclosure in the described solution.

It was discovered that the combination of using at least one nucleating agent and at least one blowing agent in certain quantities improves the quality of the polymer foam by decreasing the polymer foam density and by improving the quality of the cellular structure of the polymer foam.

According to one specific embodiment, the polymer foam comprises a nucleating agent in an amount of 0.05 to 10 weight-%, or 0.05 to 7 weight-%, or 0.1 to 5 weight-%, or 0.1 to 3 weight-%, or 0.1 to 1 weight-%, or 0.15 to 0.6 weight-%, based on the combined total weight of the said first and second polymers used. Further, the foam has been manufactured by using a blowing agent in an amount of 0.5 to 10 weight-%, or 0.5 to 7 weight-%, or 0.5 to 5 weight-%, or 1 to 5 weight-%, or 1 to 4 weight-%, or 1.5 to 3 weight-% based on the combined total weight of the said first and second polymers used.

It was also discovered that using a combination of certain nucleating agents and blowing agents has very favorable effect on the quality of the polymer foams.

The quality of the polymer foam is determined by the density of the foam, by the cell structure of the foam, and by the cell size of the foam. Polymer foams with low density are favored, as the lower density makes the foam lighter weight for the applications. For example, in automotive or in packaging it is desirable to make the final product as light as possible to save on fuel costs or transport costs. Besides being light weight, the polymer foam must also have good mechanical performance, stability, and it must not be brittle. These properties can be achieved by obtaining polymer foams with stable cell structure, small cell size, and uniform cells. Foams with very large cells are perhaps hard, but brittle, and therefore lack in mechanical properties. Foams with un-uniform cell structure may have similar problems. Therefore, it is desirable, that the polymer foams are light weight, but with small and uniformly sized and stable cells.

The inventors discovered that certain combinations of the nucleating agents and the blowing agents gave polymer foams with low density, good cell structure, and small cell size. Also, the polymer foams were stable despite the difference of the melting points of the polymers. It is surprising for example that the polymer blends having up to 30 weight-% of the PBS polymer, can form stable polymer foams with a stable cellular structure. This effect is obtained as a combination of blowing agent and a nucleating agent.

Some very specific embodiments are illustrated in the examples, as described below. It is illustrated in the examples, that in polymer blends containing 30 weight-% of for example PBS polymer this effect is very clear. When no nucleating agent is used, the polymer foam cell structure is poor. With 1.5 weight-% of CO₂ as a blowing agent and various amounts of nucleating agents talc and CaCO₃ the foam cell quality is medium. However, surprisingly when 3.0 weight-% of CO₂ as a blowing agent and 0.3 weight-% of talc as a nucleating agent is used the polymer foam cell quality is good. This clearly shows the combined effect of the nucleating agent and the blowing agent.

It is also illustrated in the examples, that similar effects are seen with polymer blend containing 20 weight-% of for example PBS polymer, and polymer blend containing solely recycled polymer blend. When talc is used as a nucleating agent in an amount of 0.3 weight-%, and CO₂ is used as a blowing agent in an amount of 1.5 weight-%, the polymer foam cell quality is medium. However, when 0.3 weight-% of talc as a nucleating agent is used combined with 3.0 weight-% of CO₂ as a blowing agent the polymer foam cell quality is good. This also shows the combined effect of the nucleating agent and the blowing agent.

It is further illustrated in the examples, that the combined effect is also apparent with polymer blend containing only 8 weight-% of the PBS polymer. The foam samples made with this blend, and by using 0.3 weight-% of talc as a nucleating agent, and either 1.5 weight-% or 3.0 weight-% of CO₂ as a blowing agent, are of good quality regarding the polymer foam cell structure. However, here the combined effect is seen in the density, as the density of the polymer foam decreases from 74.9 g/cm³ to 54.2 g/cm³ as the blowing agent weight-% is increased from 1.5 weight-% to 3.0 weight-% respectively.

It is illustrated in the examples that there is a combined effect of the used nucleating agents and the used blowing agent to the quality of the polymer foam cellular structure and the density of the polymer foam. It is illustrated that the combined effect of the nucleating agents and the blowing agents is apparent with many different proportions of the polymers used in the polymer foams.

According to one specific embodiment, the polymer foam comprises talc and/or calcium carbonate as a nucleating agent and that the foam has been manufactured by using nitrogen and/or carbon dioxide as a blowing agent.

Further, chain extenders can be used in the manufacturing of polymer foams. Chain extenders are reactive additives, or compounds that can form bonds with several polymer chain ends. By using chain extenders more complex polymer chain structures are created. The typical effects are increase in the tensile properties with extending and branching. Densities of the foams decrease, and tensile properties improve. Typical chain extenders are for example low molecular weight aliphatic or aromatic diols or diamines, chain extenders can also be based on diesters or amino acids that can be either diol or diamine terminated, some examples include ethylene glycol, diethylene glycol, propylene glycol, dipropylene glycol, 1,4-butanediol, 2-methyl-1,3-propylene diol, N,N′-Bis(2-hydrosypropylaniline), water, 1,2-di(2-hydroxyethyl) hydroquinone, diethanolalamine, 1,1,1-trimethylol propane, glycerol, dimethylol butanoic acid, hydrazine, ethylene diamine, isophorone diamine, 4,4′-bis(sec-butylamine)dicyclohexylmethane, 4,4′-bis(sec-butylamine)diphenylmethane, diethyltoluene diamine, 4,4′-methylene bis(2-chloroaniline), 4-chloro-1,5-diamino-benzoic acid isobutylester, 3,5-dimethylthio-toluene diamine, trimethylene glycol-di-p-aminobenzoate, 4,4′-methylene bis(3-chloro-1,6-diethyleniline), 1,2-ethylene diol, 2-(methylalamino) ethanol, 1,4-butanediamine, ethylene diamine, diaminopropane, cyclohexane diphenylalanine, 1,3-propanediol, pentaerythritol, or polyurethane polymers.

According to an embodiment, the polymer foam is manufactured using at least one chain extender.

Further, cross-linkers can be used in the manufacturing of polymer foams. Cross-linkers are reactive additives, or compounds that can chemically bind polymer chains together resulting to bonds or short sequences of bonds that link one polymer chain to another. By using cross-linkers more complex polymer chain structures are created and the resulting cross-linked polymer can have new properties such as mechanical, absorbance, increased melt strength, or thermoset properties. Cross-linking agents can be for example peroxides, silanes, azo compounds, or sulphur compounds, imides, hydrazides, azides, amines, epoxides, isocyanates, glutaraldehyde, dicarboxylic acids, citric acid, anhydrides, boric acid, or the cross-linking can also be achieved by UV radiation cross-linking, ultrasound crosslinking, or gamma radiation cross-linking.

According to an embodiment, the polymer foam is manufactured using at least one cross-linker.

Further, fillers can be used in the manufacturing of polymer foams. Fillers can be used to improve the mechanical properties of the polymer foam. Fillers can also be used to bring new functional properties, such as flame retardant or antioxidant properties. The use of fillers can also improve the renewable content of polymer foams. Suitable fillers can be for example silicon dioxide, carbon black, clay, calcium sulfate, boron nitride, aluminum trihydrate, magnesium hydroxide, cellulose fiber, glass fiber, carbon fiber, reinforcing filler, wood flour, wood dust, wood particles, heat treated wood particles, wood shavings, nano additives, nanocellulose, cellulose nanowhiskers, microcrystalline cellulose, lignin fibers, textile fibers, metal particles, thermoplastic polymer fibers, or any combination of these. Filler can also be borates (zinc borate), diatomite, calcium carbonate, titanium dioxide, zinc oxide, zirconium oxide, iron oxide, ultramarine blue, cobalt salts (e.g. stannate, phosphate, aluminate), chromium oxides, cadmium salts and oxides and lead salts and oxides, carbon nanotubes (CNT), graphene, kaolin, talc, mica, calcium metasilicate, muscovite, phlogopite, portland cement, wollastonite, magnesium silicate, barium sulphate, antimony trioxide, cotton, hemp fiber, kenaf, sisal, bamboo, viscose, ceramic particles, micro fibrillated cellulose, plasticizers, phthalates, adipates, benzoate esters (e.g. dipropylene glycol dibenzoate and their blends), citrates (e.g. sodium), glyceryl monostearate, antioxidants, erythorbic acid, ascorbic acid, sodium erythorbates, sodium benzoate, potassium sorbate, attapulgite, montmorillonite, and alginates.

According to an embodiment, the polymer foam comprises at least one filler.

Polymer foam according to this disclosure can further comprise other additives. Additives can be for example optical brighteners, slip agents, antioxidants, pigments, colorants, dyes, mold release agents, impact modifiers, thermal stabilizers, whitening agents, antistatic agents, processing aids, UV stabilizers, lubricants, minerals, flow aids, flame retardants, additional polymers, and combinations thereof.

The additives can be used as solids, liquids, or as masterbatches. When a masterbatch is used the base polymer can be any of the polymers used in the polymer blends to produce the polymer foams, or it can be other polymer such as aliphatic or aliphatic-aromatic polyester or co-polyester. The base polymer can also be a polylactide. The base polymer can also be a conventional plastic polymer such as polyolefin, nylon, polystyrene, or any other thermoplastic polymer.

According to an embodiment, the polymer foam comprises at least one additive.

Polymer foam according to this disclosure can further comprise other polymers. The polymer foam can further comprise a third polymer, such as polyethylene, polypropylene, polyamides, polyimides, styrene maleic anhydride, or block copolymers such as styrene-butadiene block copolymers, styrene-isoprene block copolymers, or other polymers where styrene monomer is being used, such as SIBS or SEBS. The third polymer can also be a polyimide.

By the expression “recycling” or “recycled” should be understood in this specification, unless otherwise stated, the process, or obtained by the process, of reprocessing and reusing a material so that the molecules in the material are obtained back in reuse either as polymers, monomers, or smaller chemical building blocks. Recyclability refers to the ability to recycle a material for re-use. Preferably, polymer foams should be recyclable with either mechanical recycling or chemical recycling to enable re-use of the molecular material. This is clearly stated in the European Commission reports (Plastics Strategy 2018) as well as in the basic principles of Circular Economy.

Polymer foams are often not easily recyclable for re-use. In fact, with many commonly used foam materials such as polyurethane the recycling is under-developed.

“Mechanical recycling” is for example the process of taking a polymer foam and feeding it into a shredder, melting it, compounding it into a strand, and then pelletizing the strand. These recycled pellets can then be made into a new polymer foam product.

“Chemical recycling” is for example the process of taking a polymer foam and processing the material into small chemical components, for instance syngas, the mixture of hydrogen, H₂, and carbon monoxide, CO. These chemical building blocks can then be used directly in the making of new monomers for a new polymer product.

Different parts of the polymers can be recycled in different way. Cellulose derivatives can undergo chemical recycling. Further, many types of organic polymers can be used as feedstocks for chemical recycling. Typically, the outcome of the chemical recycling process is for example syngas, a combination of hydrogen H₂ and carbon monoxide CO gases.

Re-producing the cellulose polymer structure itself as the outcome of chemical recycling is however currently not done. However, the chemicals used in the modification of the cellulose can be produced from chemically recycled feedstocks. For instance, the propionic ester groups and acetate groups in cellulose acetate propionate can be produced from the chemically recycled feedstocks.

Furthermore, several polymers, such as polyesters and polylactides, can be used as feedstocks for chemical recycling. The outcomes of their recycling process can vary depending on the process that is being used. Polyesters and polylactides can be either hydrolysed or depolymerized to the oligomers, dimers, or monomers. Also, the polymer can be rebuilt by using an esterification, condensation, or ring-opening processes. Polyesters and polylactides can also be used in thermal chemical recycling processes to produce for instance syngas (or other products). Also, catalytic pyrolysis can be used. This mixture can then be further used to build monomers, or other chemical building blocks. Therefore, polymers like polyesters and polylactides can be used as feedstock in chemical recycling processes. In addition, polymers like polyesters and polylactides can be manufactured from the materials which are the outcome of chemical recycling processes.

According to an embodiment, the polymer foam comprises chemically recycled content.

According to one embodiment, the polymer foam contains 5 to 80 weight-%, or 20 to 70 weight-%, or 30 to 60 weight-%, or 40 to 50 weight-% chemically recycled content based on the total weight of the polymer foam. The amount may be for example 10 to 80 weight-%, or 30 to 50 weight-% chemically recycled content based on the total weight of the polymer foam. The amount of chemically recycled content may also be for example 40 to 80 weight-%, or 50 to 70 weight-%, or 60 to 75 weight-%. Preferably, the amount of chemically recycled content is 5 to 40 weight-%.

Currently, a cellulose polymer derivative cannot be entirely made with chemically recycled content. Typically, the ester moieties in the cellulose acetate propionate can be made from chemically recycled content. In practice, the maximum chemically recycled content in the cellulose derivative therefore is defined by the weight-% of the ester moieties to the total weight of the cellulose polymer derivative. This may typically vary from 10 weight-% to 55 weight-% depending on the ester moiety and the degree of substitution. This is the range for the maximum chemically recycled content in the cellulose polymer derivative as weight-% of the total weight of the cellulose polymer derivative.

For other polymers, such as aliphatic polyesters, aliphatic-aromatic polyesters, and co-polyesters, and polylactides, can be entirely made with chemically recycled feedstocks. Therefore, the maximum chemically recycled content for e.g. polyester is 100 weight-%.

When the polymer foams according to this disclosure are produced, the chemically recycled content may typically vary from 50 weight-% to up to 80 weight-% if all ester groups in the cellulose-based polymer, such as a cellulose polymer derivative, and the second polymer, such as a polyester or polylactide, are made from chemically recycled materials.

According to one specific embodiment, the chemically recycled content in the polymer foam is introduced within the cellulose acetate propionate. The propionate obtained via chemical recycling is more environmentally friendly than the alternative known methods.

Further, the polymer foam can be manufactured with mechanically recycled polymer blends. According to one embodiment, the polymer foam comprises mechanically recycled polymer blend.

According to one embodiment, the polymer foam contains 5 to 100 weight-% mechanically recycled content based on the total weight of the polymer foam. The amount of the mechanically recycled content may also be for example 10 to 95 weight-%, or 15 to 90 weight-%, or 20 to 85 weight-%, or 25 to 80 weight-%, or 30 to 75 weight-%. The mechanically recycled polymer blends have shown a good foam formation property, which make them suitable for various foam applications. The mechanically recycled content may also be 5 weight-%, or 10 weight-%, or 20 weight-%, or 30 weight-%, or 40 weight-%, or 50 weight-%, or 60 weight-%, or 70 weight-%, or 80 weight-%, or 90 weight-%, or 100 weight-% of the total polymer blend used in the manufacturing of the polymer foam.

According to one embodiment, the polymer foam contains both mechanically and chemically recycled content.

According to a specific embodiment, the polymer foam comprises recycled polymer composition comprising cellulose acetate propionate (CAP) and polybutylene succinate (PBS) in an amount of 5 to 100 weight-%, or 5 to 90 weight-%, or 20 to 80 weight-%, or 20 to 70 weight-%, or 20 to 50 weight-% based on the combined total weight of the said first and second polymers used.

According to one embodiment, the polymer foam can have low environmental impact and low carbon footprint.

The disclosure also relates to a method for manufacturing a polymer foam. The method of this disclosure comprises the following steps:
providing cellulose acetate propionate (CAP) and a second polymer selected from an aliphatic or an aliphatic-aromatic polyester or an aliphatic or an aliphatic-aromatic co-polyester, or a polylactide,
mixing said cellulose acetate propionate (CAP) and said second polymer with at least one blowing agent and at least one nucleating agent to obtain a polymer mixture,
forming said polymer mixture into a polymer foam by using a foam producing method and obtaining a polymer foam.

According to an embodiment, the polymer foam is made by extrusion foaming, bead foam extrusion, bead foam process, autoclave foaming, or foam injection molding methods.

Extrusion foaming is a continuous process. In extrusion foaming, cellular structure is obtained by the expansion of a gaseous phase. The gaseous phase can be obtained by a chemical reaction with chemical blowing agents. The gaseous phase can also be obtained by infusing a physical blowing agent into the polymer melt to render a homogeneous mixture of the blowing agent and the polymer melt resulting in a lower viscosity of the melt. By reducing the temperature, the pressure increases, and the cellular structure is formed by separation of the dissolved gas from the liquid phase.

The bead foam extrusion or bead foam process is a multistep process where the extrusion of gas loaded non-foamed beads is followed by expansion of the beads.

In autoclave foaming the autoclave is loaded with the polymer and the blowing agent under pressure.

In foam injection molding the foaming formation and injection molding processes are combined to for lightweight injection molded articles.

According to one specific embodiment, the polymer foam is made by extrusion foaming method. This method has been shown to work well with the polymers of this disclosure in the described solution.

Foaming temperature is an important factor in the extrusion foaming. In extrusion foaming, polymer foams are typically produced so, that the foaming temperature is below or near the transition temperature of the polymer used. This is due to the fact, that blowing agents act as plasticisers. Lowering temperature is also necessary to reduce polymer viscosity to effectively stabilize the cellular structure. Also, as the blowing agent, such as CO₂, must diffuse out of the polymer foam structure and be replaced by air as the polymer foam is still cooling down, an unstable polymer foam would easily collapse in the under pressure formed by the diffusion.

According to an embodiment, the foaming temperature is close to or below the melting point of cellulose acetate propionate when the second polymer is selected from the group of polymers with relatively low melting point and relatively low glass transition temperature.

According to an embodiment, the polymer foam is manufactured using a foaming temperature 220° C. or less, or 210° C. or less, or 205° C. or less, or 200° C. or less or 195° C. or less. The foaming temperature can also be between 120° C. and 210° C., or between 130° C. and 205° C., or between 140° C. and 200° C., or between 150° C. and 195° C.

According to an embodiment, the foaming temperature is close to or above the melting point of cellulose acetate propionate when the second polymer is selected from the group of polymers with relatively high melting point and relatively high glass transition temperature.

According to an embodiment, the polymer foam is manufactured using a foaming temperature 300° C. or less, or 250° C. or less, or 230° C. or less.

According to an embodiment, the polymer foam is manufactured with a die pressure of 20 to 300 bar, 20 to 200 bar, or 30 to 150 bar, or 40 to 130 bar, or 40 to 120 bar, or 45 to 105 bar.

According to an embodiment, the polymers CAP and said second polymer are first melt-mixed to form a granulate product.

According to an embodiment, obtaining the polymer blend is performed by melt-mixing. The melt-mixing is performed at a temperature between 200° C. and 300° C. Preferably the temperature is between 200° C. and 270° C., or between 210° C. and 250° C., or between 210° C. and 230° C.

Alternatively, the two polymers can be added in the foam process directly without melt-mixing.

According to an embodiment, obtaining a polymer blend is done by a recycling process.

Nucleating agent used in the foam process can be mixed with the polymer granulates prior to the foaming process. The nucleating agent can also be added directly in the foaming process using a feeder. According to an embodiment, the nucleating agent is mixed with the polymer blend prior to foaming process.

Blowing agents used in the foam process can be added in one step, or in two steps, or in several steps depending on the foam process. Blowing agent can be fed into the process using a feeder or a pump. Blowing agent can also be added prior to the foam process. Blowing agent can be added in gaseous form or in liquid form. Chemical blowing agents can also be added in solid form.

According to an embodiment, the method further comprises a step wherein the obtained polymer foam is processed into an article using a method selected from the group consisting of injection molding, 3D printing, deep drawing, cutting, sheeting, and any combination of these.

According to an embodiment, the polymer foam can be a thermoplastic polymer foam. The polymer foam can also be a thermoset polymer foam. The polymer foam can also be a closed-cell polymer foam. The polymer foam can also be an open-cell polymer foam.

According to an embodiment, a polymer foam according to this disclosure has a density of 10 g/cm³ to 600 g/cm³, or 15 g/cm³ to 500 g/cm³, or 20 g/cm³ to 400 g/cm³, or 20 g/cm³ to 250 g/cm³, or 30 g/cm³ to 200 g/cm³, or 40 g/cm³ to 190 g/cm³, or 50 g/cm³ to 180 g/cm³ is obtained. The density can also be 50 g/cm³, or 60 g/cm³, or 70 g/cm³, or 80 g/cm³, or 130 g/cm³, or 140 g/cm³. The polymer foam according to this disclosure can also have a density of 150 g/cm³ to 600 g/cm³, or 150 g/cm³ to 500 g/cm³, or 150 to 400 g/cm³.

According to an embodiment, a polymer foam is obtained with an average cell size of 0.01 mm to 5 mm, or 0.05 mm to 5 mm, or 0.1 mm to 5 mm, or 0.1 mm to 3 mm, or 0.1 mm to 2 mm, or 0.1 mm to 1 mm, typically 0.2 mm to 0.7 mm, or 0.2 mm to 0.6 mm, or 0.25 mm to 0.5 mm.

As the foam forms in the process, the polymer foam expands. Expansion ratio is the diameter of the polymer foam divided by the diameter of the die used. According to an embodiment, a polymer foam with an expansion ratio of 1 to 10, or 2 to 8, or 3 to 6, 3 to 5 is obtained. The expansion ratio can also be 3, or 3.8, or 4, or 4.5.

The disclosure also relates to use of the polymer foam according to any one of the described embodiments in the manufacture of articles selected from the group consisting of packaging, acoustics, thermal insulation, automotive, sports equipment, light weight components, construction, furniture, composite fabrics, clothing, shoes and hats, car cushions, sports equipment, refrigerators, freezers, refrigerated containers, daily necessities, military industries, transportation, aerospace, seat cushions, thermal insulation materials, shockproof materials, packaging materials, building materials, automobiles, electrical and electronic applications, iron and steel industry, aerospace, thermal insulation, great thermal stability, aerospace, aircraft, marine fields, memory foam, optical products and fibers, tobacco and e-cigarette filters, medical equipment, dental molds and cushions, ear plugs, wearable audio, padding, tools, electrical engines, sound damping, motion and shock dampers, flooring, or in filtration.

Polymer foams described can be a solution to increase the renewable materials in foam applications and to make foams more sustainable and recyclable. Polymer foams described in this disclosure can be produced using renewable cellulose-based polymer, or alternatively using recycled materials. They can provide the required performance and processability. One advantage of the polymer foam according to this disclosure is that the foams can be manufactured with existing machines without major modifications. Polymer foams described herein are light weight and low density.

Below some further very specific embodiments are described.

According to one specific embodiment, the polymer foam comprises recycled polymer composition comprising cellulose acetate propionate (CAP) and polybutylene succinate (PBS).

According to one specific embodiment, the polymer foam comprises recycled polymer composition comprising cellulose acetate propionate (CAP) and polybutylene succinate (PBS) in an amount of 5 to 100 weight-%, or 5 to 90 weight-%, or 20 to 80 weight-%, or 20 to 70 weight-%, or 20 to 50 weight-% based on the combined total weight of the said first and second polymers used.

According to one specific embodiment, the polymer foam comprises an additive.

According to one specific embodiment, the polymer foam comprises a filler.

According to one specific embodiment, the polymer foam has been manufactured using a cross-linker.

According to one specific embodiment, the polymer foam comprises a third polymer.

According to one specific embodiment, the polymer foam is recyclable.

### EXAMPLES

Reference will now be made in detail to various embodiments, an example of which is illustrated in the accompanying drawing.

The description below discloses some embodiments in such a detail that a person skilled in the art is able to utilize the embodiments based on the disclosure. Not all steps or features of the embodiments are discussed in detail, as many of the steps or features will be obvious for the person skilled in the art based on this specification.

For reasons of simplicity, item numbers will be maintained in the following exemplary embodiments in the case of repeating components.

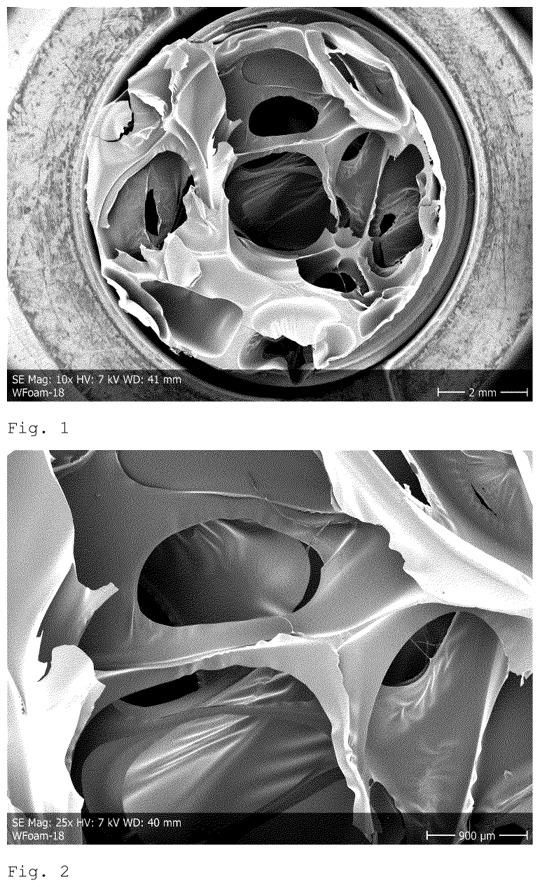

FIGS. 1 and 2 illustrate Reference Example 4, Scanning electron microscopy of a polymer foam sample 1
FIG. 1: Polymer foam sample 1, SEM image 10×
FIG. 2: Polymer foam sample 1, SEM image 25×

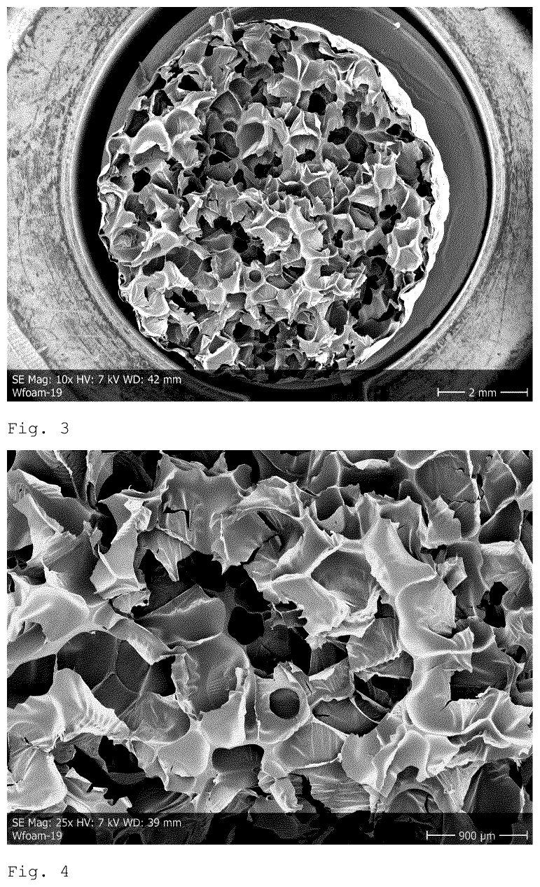

FIGS. 3 and 4 illustrate Example 5, Scanning electron microscopy of a polymer foam sample 2
FIG. 3: Polymer foam sample 2, SEM image 10×
FIG. 4: Polymer foam sample 2, SEM image 25×

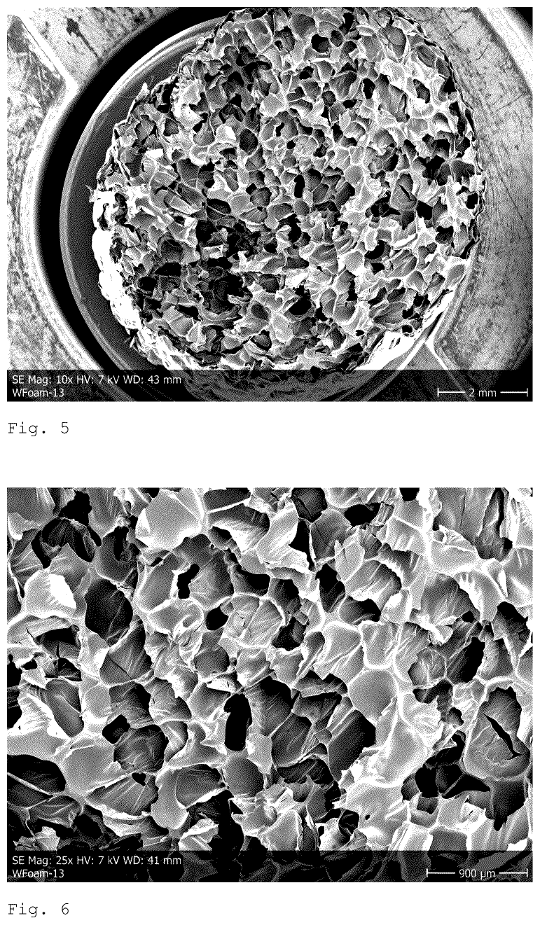

FIGS. 5 and 6 illustrate Example 5, Scanning electron microscopy of a polymer foam sample 3
FIG. 5: Polymer foam sample 3, SEM image 10×
FIG. 6: Polymer foam sample 3, SEM image 25×

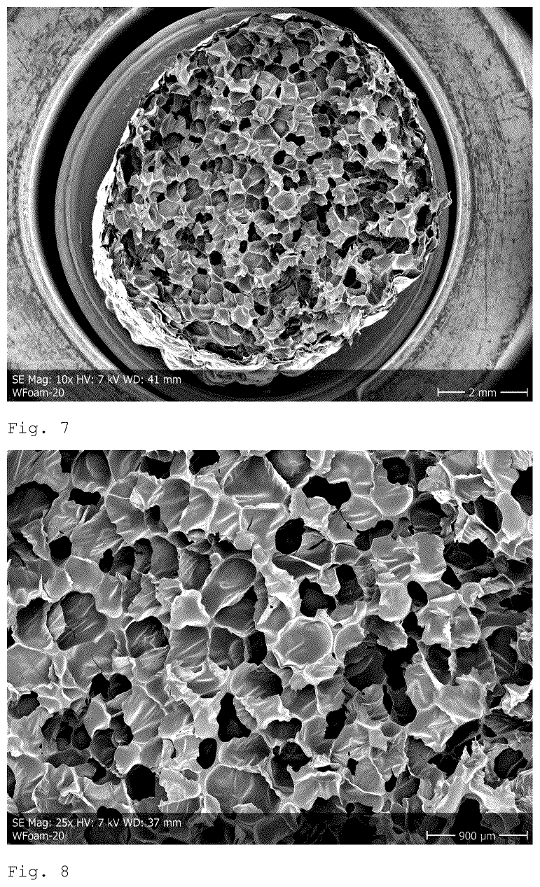

FIGS. 7 and 8 illustrate Example 5, Scanning electron microscopy of a polymer foam sample 4
FIG. 7: Polymer foam sample 4, SEM image 10×
FIG. 8: Polymer foam sample 4, SEM image 25×

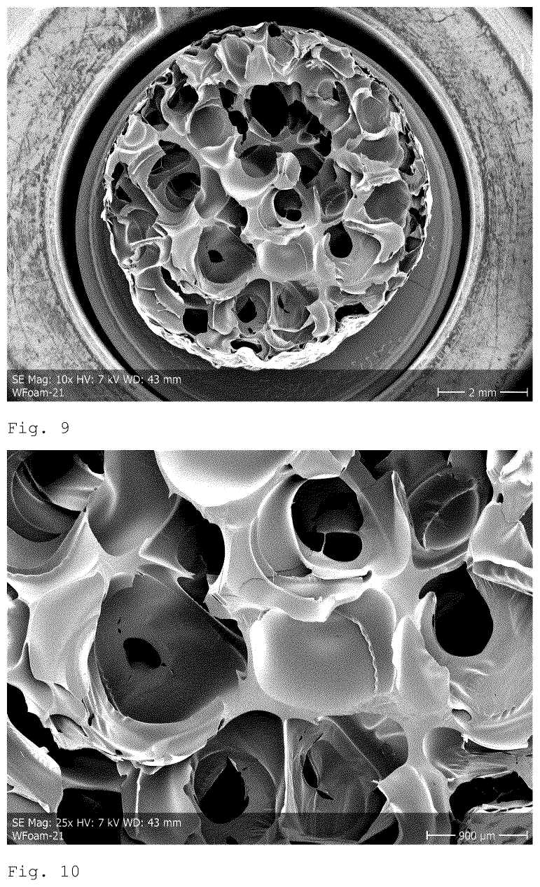

FIGS. 9 and 10 illustrate Example 5, Scanning electron microscopy of a polymer foam sample 5
FIG. 9: Polymer foam sample 5, SEM image 10×
FIG. 10: Polymer foam sample 5, SEM image 25×

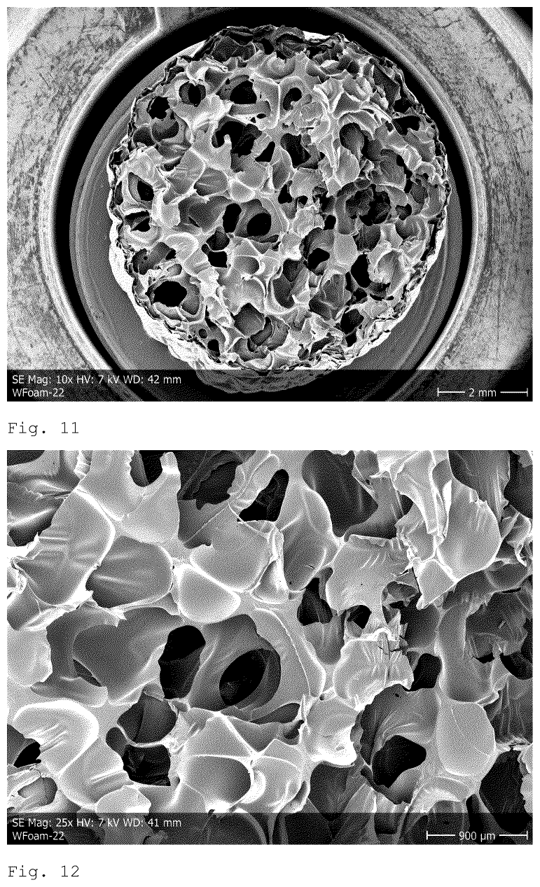

FIGS. 11 and 12 illustrate Example 5, Scanning electron microscopy of a polymer foam sample 6
FIG. 11: Polymer foam sample 6, SEM image 10×
FIG. 12: Polymer foam sample 6, SEM image 25×

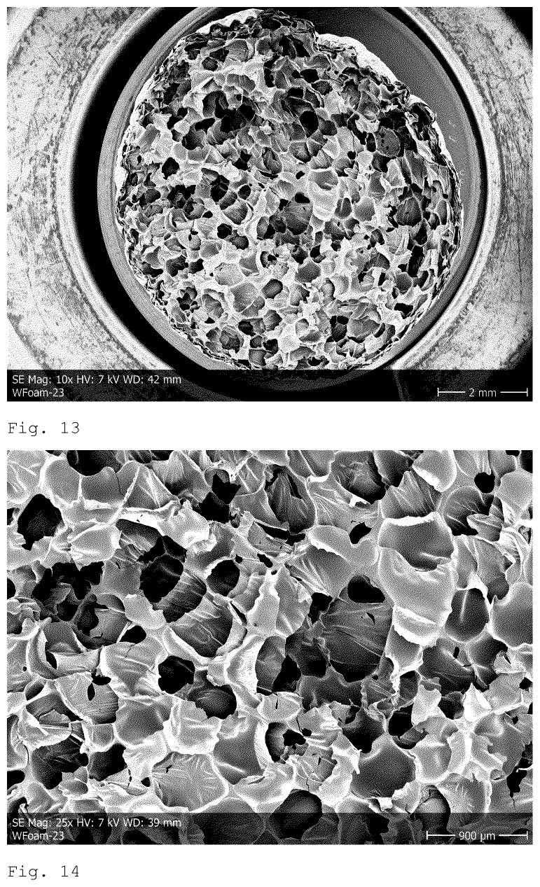

FIGS. 13 and 14 illustrate Example 5, Scanning electron microscopy of a polymer foam sample 7
FIG. 13: Polymer foam sample 7, SEM image 10×
FIG. 14: Polymer foam sample 7, SEM image 25×

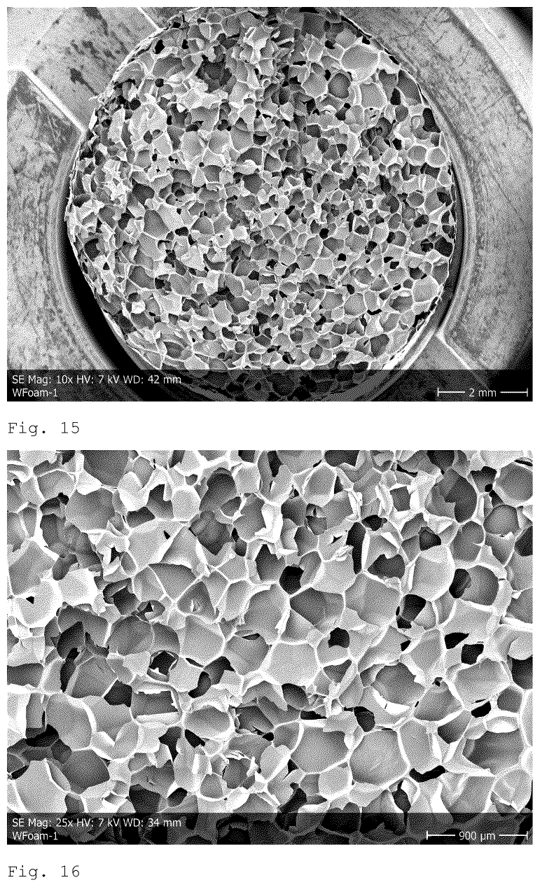

FIGS. 15 and 16 illustrate Example 5, Scanning electron microscopy of a polymer foam sample 8
FIG. 15: Polymer foam sample 8, SEM image 10×
FIG. 16: Polymer foam sample 8, SEM image 25×

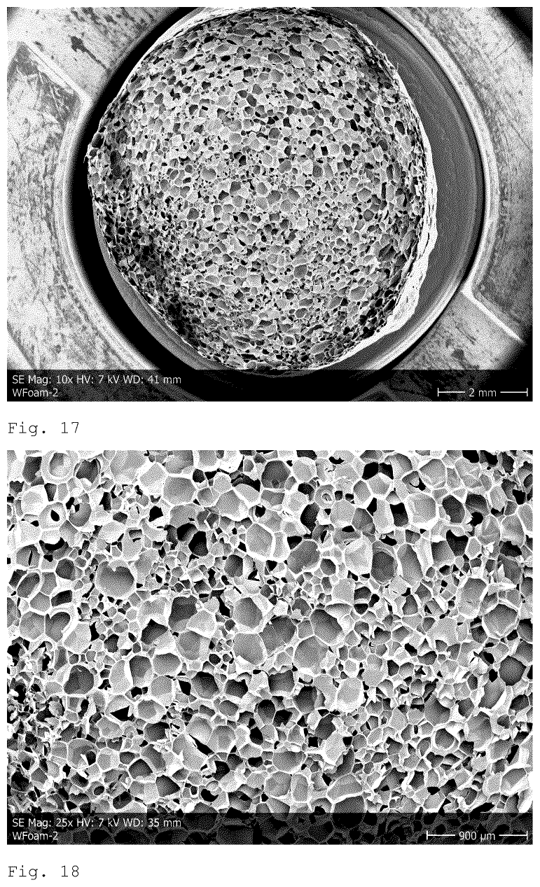

FIGS. 17 and 18 illustrate Example 5, Scanning electron microscopy of a polymer foam sample 9
FIG. 17: Polymer foam sample 9, SEM image 10×
FIG. 18: Polymer foam sample 9, SEM image 25×

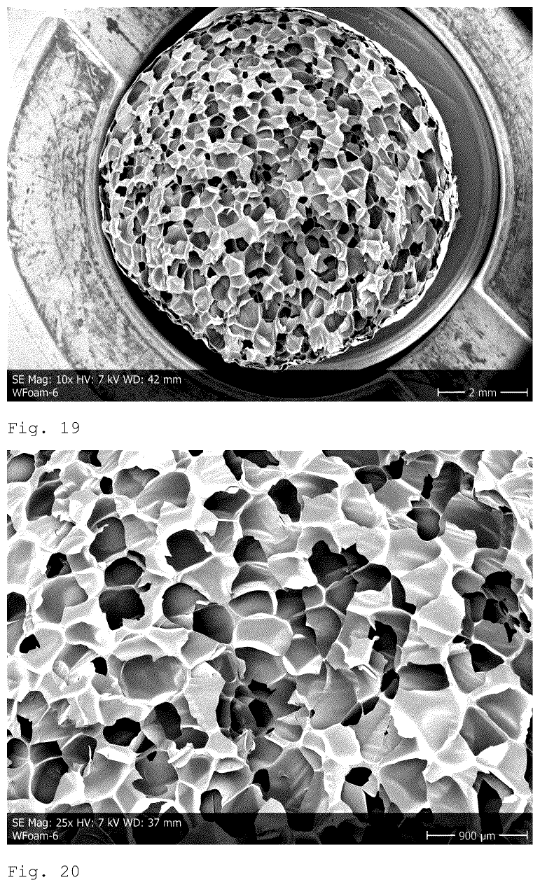

FIGS. 19 and 20 illustrate Example 5, Scanning electron microscopy of a polymer foam sample 10
FIG. 19: Polymer foam sample 10, SEM image 10×
FIG. 20: Polymer foam sample 10, SEM image 25×

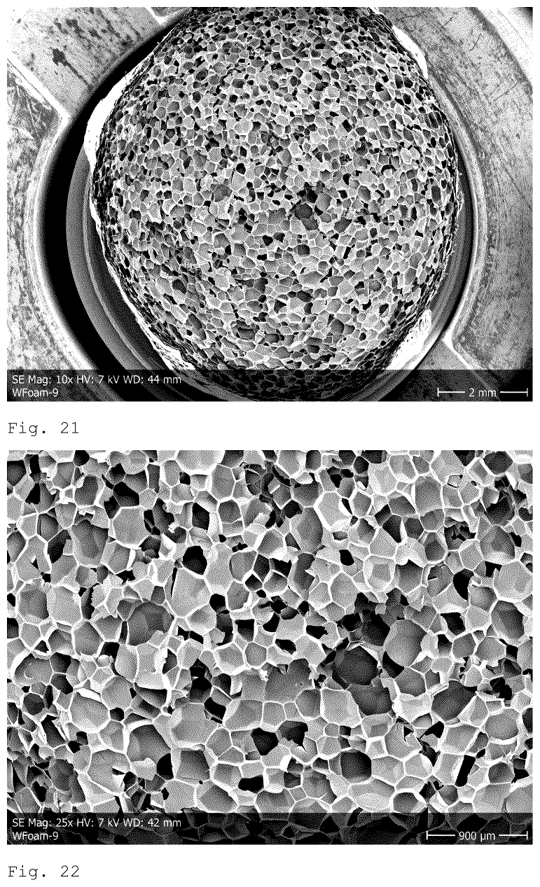

FIGS. 21 and 22 illustrate Example 5, Scanning electron microscopy of a polymer foam sample 11
FIG. 21: Polymer foam sample 11, SEM image 10×
FIG. 22: Polymer foam sample 11, SEM image 25×

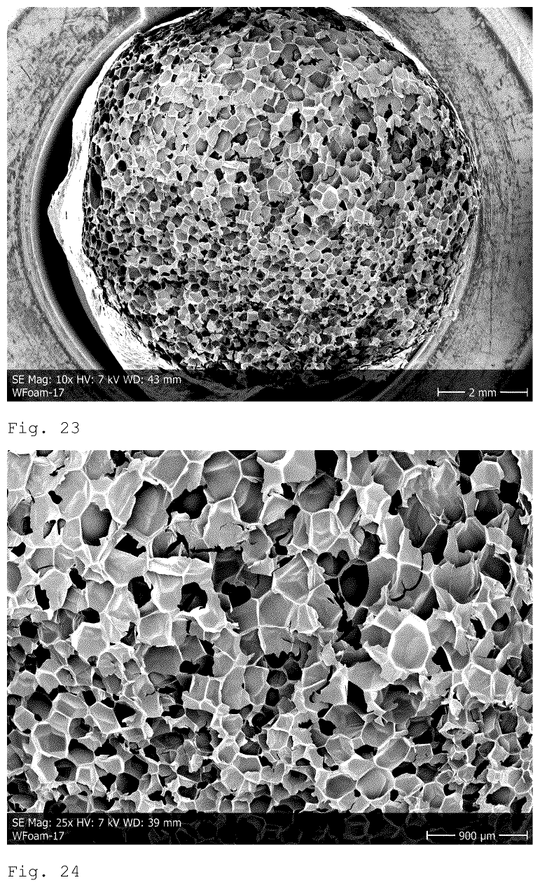

FIGS. 23 and 24 illustrate Example 5, Scanning electron microscopy of a polymer foam sample 12
FIG. 23: Polymer foam sample 12, SEM image 10×
FIG. 24: Polymer foam sample 12, SEM image 25×

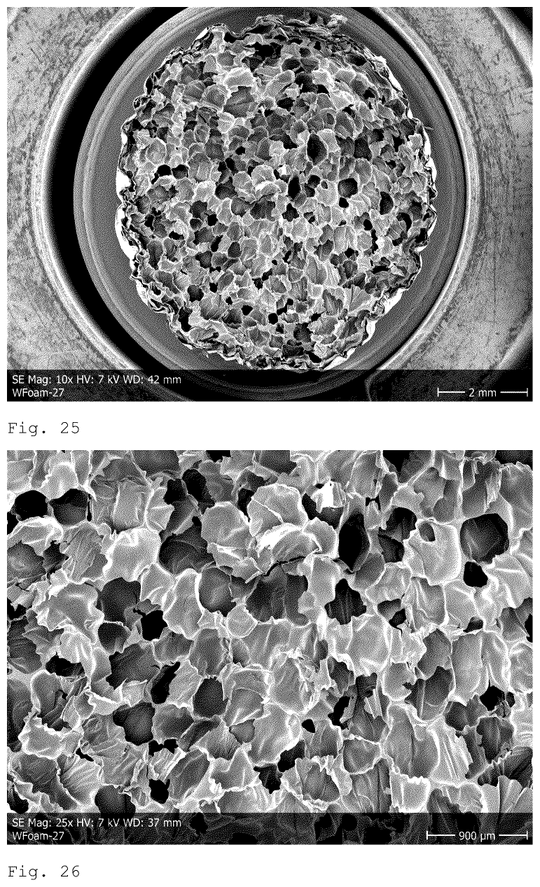

FIGS. 25 and 26 illustrate Example 5, Scanning electron microscopy of a polymer foam sample 13
FIG. 25: Polymer foam sample 13, SEM image 10×
FIG. 26: Polymer foam sample 13, SEM image 25×

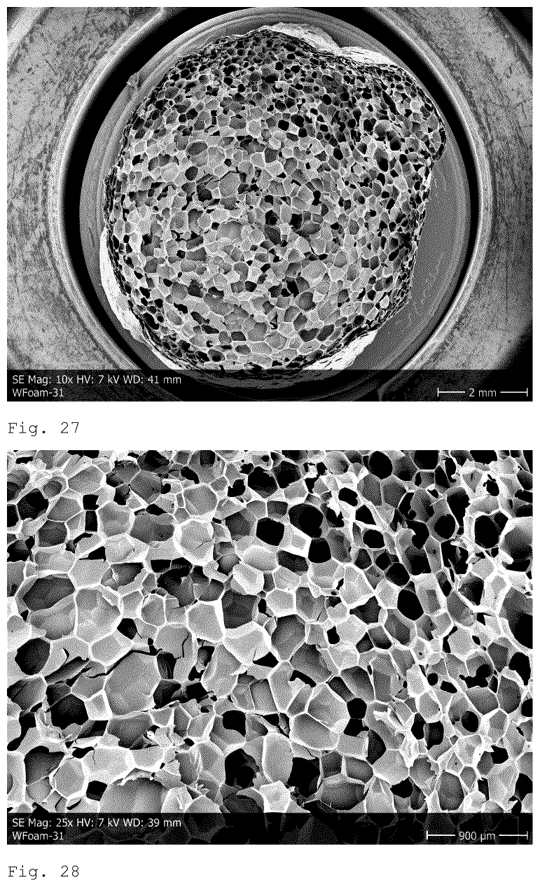

FIGS. 27 and 28 illustrate Example 5, Scanning electron microscopy of a polymer foam sample 14.
FIG. 27: Polymer foam sample 14, SEM image 10×
FIG. 28: Polymer foam sample 14, SEM image 25×
   The following polymeric raw materials have been used in the Examples; properties are identified in Table 1 to Table 3.

TABLE 1
Cellulose acetate propionate (CAP)

| | | | | | Eluent/ |
|---|---|---|---|---|---|
| | | Mn | Mw | | HPSEC |
| Entry | Compound | g/mol | g/mol | PD | system |
| 1 | CAP | 90,000 | 221,000 | 2.5 | Chloroform |

TABLE 2
Polybutylene succinate (PBS)

| | | | | | Eluent/ |
|---|---|---|---|---|---|
| | | Mn | Mw | | HPSEC |
| Entry | Compound | g/mol | g/mol | PD | system |
| 1 | PBS | 76,000 | 215,000 | 2.8 | Chloroform |

The number average molar mass measurements (Mn) were performed with size exclusion chromatography (SEC) using chloroform eluent for the number average molar mass measurements, the samples were dissolved overnight using chloroform (concentration of 1 mg/ml). Samples were filtered (0.45 μm) before the measurement.
The SEC measurements were performed in chloroform eluent (0.6 ml/min, T=30° C.) using Styragel HR 4 and 3 columns with a pre-column. The elution curves were detected using Waters 2414 Refractive index detector. The molar mass distributions (MMD) were calculated against 10×PS (580-3,040,000 g/mol) standards, using Waters Empower 3 software.

TABLE 3
Tg values and melting points of used polymers.

| Entry | Polymer | Tg | Mp |
|---|---|---|---|
| 1 | PBS | −32° C. | 115° C. |
| 2 | CAP | 140-147° C. | 188-210° C. |

### Example 1: Preparation of the Polymer Blends for Foam Extrusion

The polymer blends used in the foam extrusion were prepared as follows: The first polymer and the second polymer were fed into a melt-mixing or compounding process with or without additives. The compounding was done with a twin-screw compounder. The compounding can be done with strand pelletizing or underwater pelletizing. The temperatures used for the compounding process are as in Table 4.
Typical additives used in the compounding can be optical brighteners, slip agents, antioxidants, pigments, colorants, dyes, mold release agents, impact modifiers, thermal stabilizers, whitening agents, antistatic agents, processing aids, UV stabilizers, lubricants, minerals, flow aids, flame retardants, additional polymers, and combinations thereof.
The additives can be used as solids, liquids, or as masterbatches. When a masterbatch is used the base polymer can be any of the polymers used in the polymer blends 1-3, or it can be a biobased polymer such as aliphatic or aliphatic-aromatic polyester or co-polyester. The base polymer can also be a polylactide. The base polymer can also be a conventional plastic polymer such as polyolefin, nylon, polystyrene, or any other thermoplastic polymer.

TABLE 4
Preparation of polymer blends 1-3.

| | | | | | MFR |
|---|---|---|---|---|---|
| | Cellulose- | | | | 230° C./ |
| Polymer | based | Second | | Compounding | 2.16 kg |
| blend | polymer | polymer | Additive | temperature | (g/10 min) |
| 1 | CAP | PBS | | 210-220° C. | 12.8 |
| | 70% | 30% | | | |
| 2 | CAP | PBS | | 210-220° C. | 9.1 |
| | 80% | 20% | | | |
| 3 | CAP | PBS | 2% (a) | 210-220° C. | 5.2 |
| | 90% | 8% | | | |

a) The additive used in the Table 4 blend 3 is an optical brightener ob S515-N from Sukano, which is a PLA based masterbatch.

### Example 2: Preparation of Recycled Polymer Blend 4 for Foam Extrusion

Production of recycled polymer blend for foam extrusion. Blend 4 is a recycled blend.
Mixed film waste containing blends 1 and 2 with additives was fed into a shredder, then melted and further extruded into a strand and pelletized with compounding process temperatures being between 210-220° C. The granulate obtained was clear and transparent. This recycled granulate was used in the foam extrusion tests as recycled blend 4.

The recycled blend can be mixed with virgin polymer blend. The fraction of mechanically recycled content can vary for example from 5 weight-% to 100 weight-% of the polymer foam.

### Example 3: Methods for Preparing Polymer Foams

Polymer foams were prepared with a Brabender Plastograpch EC plus 19 mm single screw extruder. The extruder was also equipped with a 0.66 cm³/rev melt pump and static mixer-type melt cooler with oil tempering. The extruder screw geometry appropriate for foaming was used that has a three-phase compression process and an increase in inner diameter at the blowing agent injection point. The extruder barrel was heated with 3 heating bands (zones) and the blowing agent was injected between zones 2 and 3. The extruder was also equipped with a round capillary die. The die geometry was 2/20 (diameter/length in mm).
Blowing agents were injected and pressurized with the Teledyne ISCO dual-syringe pump system. As carbon dioxide can be liquefied, it was dosed with the Teledyne pump. The injection pressure for carbon dioxide was 120 bar and the pump was cooled to 2° C. for liquefaction.
As nitrogen cannot be liquefied easily, it would be injected as gas. Nitrogen dosing would be done using a mass flow controller.
The blowing agent dosage was calculated as a mass percentage based on the material throughput determined by measuring a 1 min output sample by hand and weighing.
During the foam processing, the extruder barrel temperatures and melt pump temperatures were kept constant. The temperature was 220° C. The melt cooler temperature and the die temperature were changed. The melt cooler temperature and the die temperature are called together the foaming temperature.
The polymer blends 1-3 were dried over night under vacuum at 60° C. prior to use. The recycled blend 4 was not dried.
The nucleating agents in Example 5 were dusted on top of the polymer blend granulate and mixed prior to feeding into the foam extruder.
The densities of the polymer foam samples were determined with a liquid submersion technique. The density of the foam sample was done by first weighing the sample in air, and then as submersed in distilled water. Pervitro 75% Fuer solution was used to aid decrease the surface tension of the water.

$$ρ ( foam ) = \frac{foam mass ( in air )}{foam mass ( in air ) - foam mass ( in water )} \times ρ ( water )$$

Scanning Electron Microscopy (SEM) was used for imaging the cell structure and cell size of the polymer foam samples. Prior to imaging, the foams were frozen with liquid nitrogen, fractured, and the fractured surfaces were gold-coated with the Bal-Tec SCD050 sputter coater. JEOL JSM-6360LV was used for the SEM imaging.

### Reference Example 4: Foam Extrusion without Nucleating Agents

Polymer blend 1 was introduced in the foam extrusion process with 1.5 weight-% of CO₂ as the blowing agent. Foaming temperature of 180° C. was used.

TABLE 5
Preparation of a polymer foam without a nucleating agent

| | Polymer | Nucleating | Blowing | Foaming | Die | Foam |
|---|---|---|---|---|---|---|
| Foam | blend | agent | agent | temperature | pressure | density |
| sample | used | (weight-%) | (weight-%) | (° C.) | (Bar) | (g/cm³) |
| 1 | 1 | — | CO₂ (1.5%) | 180 | 59 | 181.9 |

Polymer foam was obtained but the cell structure was not of good quality, as the cell size was large and ununiform. The density was too high, and the foam was brittle, and cells tended to collapse or rip to break (FIG. 1).

### Example 5: Polymer Foam Extrusion with Nucleating Agents

Polymer blends 1˜4 were introduced in the foam extrusion process. Talc and CaCO₃ were used as nucleating agents and their quantities were varied. Talc used was Finntalc MO5SL with a median particle size of 2.2 μm. CaCO₃ used was Omycarb 2-GU calcium carbonate with a median particle size of 2.0 μm.
The blowing agent used was CO₂ and the quantity was varied. Foaming temperatures were varied between 155-195° C.

TABLE 6
Preparation of polymer foams with nucleating agents and their densities

| | Polymer | Nucleating | Blowing | Foaming | Die | Foam |
|---|---|---|---|---|---|---|
| Foam | blend | agent | agent | temperature | pressure | density |
| sample | used | (weight-%) | (weight-%) | (° C.) | (Bar) | (g/cm³) |
| 2 | 1 | Talc (0.15%) | CO₂ (1.5%) | 180 | 59 | 130.9 |
| 3 | 1 | Talc (0.30%) | CO₂ (1.5%) | 180 | 62 | 140.1 |
| 4 | 1 | Talc (0.60%) | CO₂ (1.5%) | 180 | 59 | 126.9 |
| 5 | 1 | CaCo₃ (0.15%) | CO₂ (1.5%) | 180 | 60 | 178.3 |
| 6 | 1 | CaCo₃ (0.30%) | CO₂ (1.5%) | 180 | 60 | 141.0 |
| 7 | 1 | CaCo₃ (0.60%) | CO₂ (1.5%) | 180 | 62 | 131.9 |
| 8 | 3 | Talc (0.30%) | CO₂ (1.5%) | 195 | 59 | 74.9 |
| 9 | 3 | Talc (0.30%) | CO₂ (3.0%) | 185 | 67 | 54.2 |
| 10 | 2 | Talc (0.30%) | CO₂ (1.5%) | 185 | 58 | 105.3 |
| 11 | 2 | Talc (0.30%) | CO₂ (3.0%) | 175 | 86 | 62.6 |
| 12 | 1 | Talc (0.30%) | CO₂ (3.0%) | 165 | 105 | 86.4 |
| 13 | 4 | Talc (0.30%) | CO₂ (1.5%) | 170 | 45 | 133.9 |
| 14 | 4 | Talc (0.30%) | CO₂ (3.0%) | 155 | 80 | 75.8 |

The effect of the nucleating agent in the foam quality and density is clear. Comparing the Foam sample 1 in Table 5 and samples 2 to 7 in Table 6 it is seen that the use of a nucleating agent clearly improves the density of the foams. From the density measurements it is seen that talc is more efficient nucleating agent than CaCO₃ as the density level of around 130 (g/cm³) of the polymer foam with talc is achieved by using only 0.15 weight-% of the nucleating agent (Foam sample 2) and there is no great difference in the foam density if higher amounts of talc are used (Foam samples 3 and 4). To achieve similar density level with CaCO₃ a quantity of 0.60 weight-% of CaCO₃ is required (Foam sample 7).
As the quantity of CO₂ is varied between 1.5 weight-% and 3.0 weight-%, the effect is clearly seen with all of the polymer blends 1 to 4. Higher loading of CO₂ gave clearly lower density for the polymer foams with all polymer blends. The lowest densities were achieved with polymer blend 3 as the lowest density was 54.2 g/cm³ (Foam sample 9).

TABLE 7
Cell properties of the polymer foam samples

| | | Polymer | Nucleating | Blowing | Foam | Average |
|---|---|---|---|---|---|---|
| Foam | FIG. | blend | agent | agent | cell | cell size |
| sample | No. | used | (weight-%) | (weight-%) | quality | (mm) |
| 1 | 1 | 1 | — | CO₂ (1.5%) | poor | 2.81 |
| 2 | 2 | 1 | Talc (0.15%) | CO₂ (1.5%) | medium | 0.65 |
| 3 | 3 | 1 | Talc (0.30%) | CO₂ (1.5%) | medium | 0.51 |
| 4 | 4 | 1 | Talc (0.60%) | CO₂ (1.5%) | medium | 0.44 |
| 5 | 5 | 1 | CaCo₃ (0.15%) | CO₂ (1.5%) | medium | 1.18 |
| 6 | 6 | 1 | CaCo₃ (0.30%) | CO₂ (1.5%) | medium | 0.83 |
| 7 | 7 | 1 | CaCo₃ (0.60%) | CO₂ (1.5%) | medium | 0.52 |
| 8 | 8 | 3 | Talc (0.30%) | CO₂ (1.5%) | good | 0.37 |
| 9 | 9 | 3 | Talc (0.30%) | CO₂ (3.0%) | good | 0.19 |
| 10 | 10 | 2 | Talc (0.30%) | CO₂ (1.5%) | medium | 0.36 |
| 11 | 11 | 2 | Talc (0.30%) | CO₂ (3.0%) | good | 0.23 |
| 12 | 12 | 1 | Talc (0.30%) | CO₂ (3.0%) | good | 0.27 |
| 13 | 13 | 4 | Talc (0.30%) | CO₂ (1.5%) | medium | 0.42 |
| 14 | 14 | 4 | Talc (0.30%) | CO₂ (3.0%) | good | 0.28 |

All the polymer foam samples with nucleating agents (Foam samples 2 to 14) in Table 7 have a cellular structure as can be seen in FIGS. 2 to 14. The basic structure of the polymer foams with nucleating agents is maintained when the foam stabilizes as coming out of the die. As the CO₂ is replaced by air in the cellular structure there is a slight under pressure formed within the polymer foam as the foam is stabilizing and cooling down. However, the quality and size of the cells varies between the samples leading to different properties of the polymer foams.
In Table 7 the poor quality of the polymer foam cells indicates that the cell size is very large, or that the cells have ripped during the foam formation or collapsed during cooling down and as the blowing agent is being diffused out of the polymer foam structure and replaced by air. Medium quality of the polymer foam cells indicates that some of the cells are partially collapsed or wrinkled during cooling down, as the blowing agent is being diffused out of the polymer foam structure and replaced by air. The good quality of the polymer foam cells indicates stable and small cells, which are not collapsed or wrinkled. This means that the foam is stable when cooling down and as the blowing agent is diffused out of the polymer foam structure and replaced by air. The material melt strength is adequate to properly withstand the stretching effects of cell formation without rupture of the cells.
In Table 7 the foam cell size is indicated as average cell size. This was measured from the SEM images (FIGS. 1 to 14).
The Figures show 10× and 25×SEM images of the polymer foams. Polymer foam sample 1 has very large cells, of which many are ripped. Polymer foams 2 to 7, and 10, and 13 have a medium quality cell structure. The cellular structure is clearly formed, but some of the cells are wrinkled or the cells are large by size. Polymer foams 8, 9, 11, 12, and 14 have a good cell structure with plenty of uniform, small cells. No wrinkling, or very little wrinkling of the cells is seen.
This shows, that even with polymer blends containing 30 weight-% of PBS polymer the cellular structure can be stable and of good quality (Foam sample 12) despite the low melting point of the PBS polymer. The average cell sizes of polymer blends 1 (Foam samples 1-7 and 12) is decreased from 2.81 mm (Foam sample 1) to 0.27 mm (Foam sample 12) with the right combination of the nucleating agent and the blowing agent. The density of the foams made with polymer blend 1 is also decreased from 181.9 g/cm³ (Foam sample 1) to 86.4 g/cm³ (Foam sample 12).
Similarly, with polymer blend 2 (Foam samples 10 and 11) the cell size and quality are improved. With the same amount of the nucleating agent, and by increasing the amount of the blowing agent from 1.5 weight-% to 3.0 weight-%, the average cell size decreases from 0.36 mm to 0.23 mm. Simultaneously, the density decreases from 105.3 g/cm³ to 62.6 g/cm³ respectively.
With polymer blend 3 and with the recycled blend 4 these effects are also clear.

It is obvious to a person skilled in the art that with the advancement of technology, the basic idea may be implemented in various ways. The embodiments are thus not limited to the examples described above; instead they may vary within the scope of the claims.

The embodiments described hereinbefore may be used in any combination with each other. Several of the embodiments may be combined together to form a further embodiment. A product, a system, a method, or a use, disclosed herein, may comprise at least one of the embodiments described hereinbefore. It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items. The term “comprising” is used in this specification to mean including the feature(s) or act(s) followed thereafter, without excluding the presence of one or more additional features or acts.

1. A polymer foam, characterized in that said polymer foam comprises
cellulose acetate propionate (CAP),
a second polymer selected from an aliphatic or an aliphatic-aromatic polyester, an aliphatic or an aliphatic-aromatic co-polyester, or a polylactide,
at least one nucleating agent, and
in that the polymer foam has been manufactured by using at least one blowing agent.

2. The polymer foam according to claim 1, characterized in that said polymer foam comprises
cellulose acetate propionate in an amount of 5 to 95 weight-%, and
said second polymer in an amount of 95 to 5 weight-% based on the total weight of said polymer foam.

3. The polymer foam according to claim 1, characterized in that said polymer foam comprises a combination of cellulose acetate propionate and said second polymer in an amount of at least 80 weight-%, or at least 85 weight-%, or at least 90 weight-%, or at least 95 weight-%, based on the total weight of the polymer foam.

4. The polymer foam according to claim 1, characterized in that said polymer foam comprises cellulose acetate propionate in an amount of 30 to 95 weight-%, or 40 to 95 weight-%, or 50 to 90 weight-%, or 55 to 90 weight-%, or 60 to 90 weight-%, or 70 to 90 weight-%, and said second polymer in an amount of 5 to 70 weight-%, or 5 to 60 weight-%, or 10 to 50 weight-%, or 10 to 45 weight-%, or 10 to 40 weight-%, or 10 to 30 weight-% based on the total weight of the polymer foam.

5. The polymer foam according to claim 1, characterized in that the second polymer is selected from the group consisting of polypropylene succinate (PPS), polybutylene succinate (PBS), polybutylene succinate adipate (PBSA), polybutylene adipate terephthalate (PBAT), polybutylene adipate (PBA), polycaprolactone (PCL), polyhydroxyalkanoate (PHA), and polybutylene sebacate (PBSE), or any combinations thereof.

6. The polymer foam according to claim 1, characterized in that the second polymer is selected from the group consisting of
polylactic acid (PLA), polyethylene furanoate (PEF), polyethylene terephthalate (PET), polybutylene terephthalate (PBT), polytrimethylene terephthalate (PTT), and polyglycolic acid (PGA), or any combinations thereof.

7. The polymer foam according to claim 1, characterized in that the second polymer is polybutylene succinate (PBS).

8. The polymer foam according to claim 1, characterized in that the at least one blowing agent is selected from the group consisting of nitrogen, carbon dioxide, water, argon, air, isobutane, n-butane, n-pentane, branched five carbon and six carbon alkanes, such as isopentane, isohexane, or 2,3-dimethyl butane, fluorocarbons or chlorofluorocarbons, such as dichloroethane, or Freon, bicarbonates, such as sodium bicarbonate, carbonates, nitrites, zinc powder, chemical compounds giving acid reactions, hydrogen peroxide, citric acid, azodicarbonamide, isocyanate compounds, nitroso foaming agents, and acylhydrazine, or any combinations thereof.

9. The polymer foam according to claim 1, characterized in that the blowing agent is nitrogen and/or carbon dioxide.

10. The polymer foam according to claim 1, characterized in that the polymer foam has been manufactured by using at least one blowing agent in an amount of 0.1 to 10 weight-%, or 0.3 to 10 weight-%, or 0.5 to 10 weight-%, or 0.5 to 7 weight-%, or 0.5 to 5 weight-%, or 1 to 5 weight-%, or 1 to 4 weight-%, or 1.5 to 3 weight-% based on the combined total weight of the cellulose acetate propionate (CAP) and the second polymer.

11. The polymer foam according to claim 1, characterized in that the nucleating agent is selected from the group consisting of talc, calcium carbonate, silica, silicate compounds, graphite, calcium hydroxide, natural waxes, polyethylene waxes, polyamide waxes, or other synthetic waxes, and stearates, such as calcium stearate, zinc stearate, aluminum stearate, and azodicarbonamide, or any combination thereof.

12. The polymer foam according to claim 1, characterized in that the nucleating agent is talc and/or calcium carbonate.

13. The polymer foam according to claim 1, characterized in that the nucleating agent has a median particle size of 0.5 to 10 μm, or 0.5 to 7 μm, or 1 to 5 μm, or 1 to 4 μm, or 1.5 to 3.5 μm or 1.5 to 3 μm.

14. The polymer foam according to claim 1, characterized in that the polymer foam comprises a nucleating agent in an amount of 0.05 to 10 weight-%, or 0.05 to 7 weight-%, or 0.1 to 5 weight-%, or 0.1 to 3 weight-%, or 0.1 to 1 weight-%, or 0.15 to 0.6 weight-%, based on the combined total weight of the cellulose acetate propionate (CAP) and the second polymer.

15. The polymer foam according to claim 1, characterized in that the polymer foam comprises a nucleating agent in an amount of 0.05 to 10 weight-%, or 0.05 to 7 weight-%, or 0.1 to 5 weight-%, or 0.1 to 3 weight-%, or 0.1 to 1 weight-%, or 0.15 to 0.6 weight-%, based on the combined total weight of the cellulose acetate propionate (CAP) and the second polymer, and that the foam has been manufactured by using a blowing agent in an amount of 0.1 to 10 weight-%, or 0.3 to 10 weight-%, or 0.5 to 10 weight-%, or 0.5 to 7 weight-%, or 0.5 to 5 weight-%, or 1 to 5 weight-%, or 1 to 4 weight-%, or 1.5 to 3 weight-% based on the combined total weight of cellulose acetate propionate and said second polymer used.

16. The polymer foam according to claim 1, characterized in that the polymer foam comprises talc and/or calcium carbonate as the nucleating agent and that the foam has been manufactured by using nitrogen and/or carbon dioxide as the blowing agent.

17. The polymer foam according to claim 1, characterized in that it is manufactured by further using a chain extender being selected from the group consisting of ethylene glycol, diethylene glycol, propylene glycol, dipropylene glycol, 1,4-butanediol, 2-methyl-1,3-propylene diol, N,N′-Bis(2-hydrosypropylaniline), water, 1,2-di(2-hydroxyethyl) hydroquinone, diethanolalamine, triethanolalamine, 1,1,1-trimethylol propane, glycerol, dimethylol butanoic acid, hydrazine, ethylene diamine, isophorone diamine, 4,4′-bis(sec-butylamine)dicyclohexylmethane, 4,4′-bis(sec-butylamine)diphenylmethane, diethyltoluene diamine, 4,4′-methylene bis(2-chloroaniline), 4-chloro-1,5-diamino-benzoic acid isobutylester, 3,5-dimethylthio-toluene diamine, trimethylene glycol-di-p-aminobenzoate, 4,4′-methylene bis(3-chloro-1,6-diethyleniline), 1,2-ethylene diol, 2-(methylalamino) ethanol, 1,4-butanediamine, ethylene diamine, diaminopropane, and cyclohexane diphenylalanine, or any combination of these.

18. The polymer foam according to claim 1, characterized in that the polymer foam is manufactured using a foaming temperature of 220° C. or less, or 210° C. or less, or 205° C. or less, or 200° C. or less, or 195° C. or less.

19. An article manufactured using the polymer foam according to claim 1.

20. (canceled)

21. A method for manufacturing a polymer foam characterized in that the method comprises the following steps:
providing cellulose acetate propionate (CAP) and a second polymer selected from an aliphatic or an aliphatic-aromatic polyester or an aliphatic or an aliphatic-aromatic co-polyester, or a polylactide,
mixing said cellulose acetate propionate (CAP) and said second polymer with at least one blowing agent and at least one nucleating agent to obtain a polymer mixture,
forming said polymer mixture into a polymer foam by using a foam producing method and obtaining a polymer foam.

22. (canceled)

23. (canceled)

24. (canceled)

25. (canceled)

26. (canceled)

27. (canceled)

28. (canceled)

29. (canceled)

30. (canceled)
